(19) United States
(12) Patent Application Publication
(10) Pub. No.: US 2012/0154295 A1
(43) Pub. Date: Jun. 21, 2012

(54) COOPERATIVE USE OF PLURAL INPUT MECHANISMS TO CONVEY GESTURES

(75) Inventors: Kenneth P. Hinckley, Redmond, WA (US); Michel Pahud, Kirkland, WA (US)

(73) Assignee: Microsoft Corporation, Redmond, WA (US)

(21) Appl. No.: 12/970,949

(22) Filed: Dec. 17, 2010

(51) Int. Cl. G06F 3/041

(52) U.S. Cl. 345/173

(57) ABSTRACT

A computing device is described which allows a user to convey a gesture through the cooperative use of two input mechanisms, such as a touch input mechanism and a pen input mechanism. A user uses a first input mechanism to demarcate content presented on a display surface of the computing device or other part of the computing device, e.g., by spanning the content with two fingers of a hand. The user then uses a second input mechanism to make gestures within the content that is demarcated by first input mechanism. In doing so, the first input mechanism establishes a context which governs the interpretation of gestures made by the second input mechanism. The computing device can also activate the joint use mode using two applications of the same input mechanism, such as two applications of a touch input mechanism.

### BACKGROUND

Handheld computing devices commonly provide a touch input mechanism or a pen input mechanism for receiving commands and other information from users. A touch input mechanism provides touch input events when a user touches a display surface of the computing device with a finger (or multiple fingers). A pen input mechanism provides pen input events when a user touches the display surface with a pen device, also known as a stylus. Some devices allow a user to enter either touch input events or pen input events on the same device.

Computing devices also permit a user to perform gestures by using one or more fingers or a pen device. For example, a gesture may correspond to a telltale mark that a user traces on the display surface with a finger and/or pen input device. The computing device correlates this gesture with an associated command. The computing device then executes the command. Such execution can occur in the course of the user's input action (as in direct-manipulation drag actions), or after the user finishes the input action

To provide a rich interface, a developer may attempt to increase the number of gestures recognized by the computing device. For instance, the developer may increase a number of touch gestures that the computing device is able to recognize. While this may increase the expressiveness of the human-to-device interface, it also may have shortcomings. First, it may be difficult for a user to understand and/or memorize a large number of touch gestures or pen gestures. Second, an increase in the number of possible gestures makes it more likely that a user will make mistakes in entering gestures. That is, the user may intend to enter a particular gesture, but the computing device may mistakenly interpret that gesture as another, similar, gesture. This may understandably frustrate the user if it becomes a frequent occurrence, or, even if uncommon, if it causes significant disruption in the task that the user is performing. Generally, the user may perceive the computing device as too susceptible to accidental input actions.

### SUMMARY

A computing device is described which allows a user to convey gestures via a cooperative use of at least two input mechanisms. For example, a user may convey a gesture through the joint use of a touch input mechanism and a pen input mechanism. In other cases, the user may convey a gesture through two applications of a touch input mechanism, or two applications of a pen input mechanism, etc. Still other cooperative uses of input mechanisms are possible.

In one implementation, a user uses a touch input mechanism to define content on a display surface of the computing device. For example, in one case, the user may use a finger and a thumb to span the desired content on the display surface. The user may then use a pen input mechanism to enter pen gestures to the content demarcated by the user's touch. The computing device interprets the user's touch as setting a context in which subsequent pen gestures applied by the user are to be interpreted. To cite merely a few illustrative examples, the user can cooperatively apply two input mechanisms to copy information (e.g., text or other objects), to highlight information, to move information, to reorder information, to insert information, and so on.

More generally summarized, the user may apply the touch input mechanism alone (without the pen input mechanism). In this case, the computing device interprets the resultant touch input event(s) without reference to any pen input event(s) (e.g., as “normal” touch input event(s)). In another scenario, the user may apply the pen input mechanism alone (without the touch input mechanism). In this case, the computing device interprets the resultant pen input event(s) without reference to any touch input event(s) (e.g., as “normal” pen input event(s)). In another scenario, the user may cooperatively apply the touch input mechanism and the pen input mechanism in the manner summarized above. Hence, the computing device can act in three modes: a touch only mode, a pen only mode, and a joint use mode.

Generally stated, the cooperative use of plural input mechanisms increases the versatility of the computing device without unduly burdening the user with added complexity. For instance, the user can easily understand and apply the combined use of dual input mechanisms. Further, the computing device is unlikely to confuse different gestures provided by the joint use of two input mechanisms. This is because the user is unlikely to accidently apply both touch input and pen input in a manner which triggers the joint use mode.

The above functionality can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative computing device that accommodates dual use of plural input mechanisms to convey gestures.

FIG. 2 shows an interpretation and behavior selection module (IBSM) used in the computing device of FIG. 1.

FIG. 3 shows an illustrative system in which the computing device of FIG. 1 can be used.

FIG. 4 shows an example of a combined use of a touch input mechanism and a pen input mechanism to select text within demarcated content.

FIG. 5 shows an example of a combined use of a touch input mechanism and a pen input mechanism to make two selections within demarcated content.

FIG. 6 shows an example of the combined use of two touch input mechanisms to establish an insertion point within demarcated content.

FIG. 7 shows an example of a combined use of a touch input mechanism and a voice input mechanism.

FIG. 8 shows an example of a combined use of a touch input mechanism and a pen input mechanism, where a pen device is used to make a selection within a menu invoked by the touch input mechanism.

FIGS. 9 and 10 show other examples in which two input mechanisms are used to invoke and then act on at least one menu.

FIG. 11 shows an example of the combined use of a touch input mechanism and a pen input mechanism which involves a gesture that is composed of multiple parts or phases.

FIG. 12 shows an example of a combined use of a touch input mechanism and a pen input mechanism, where the pen input mechanism is applied following an input action applied by the touch input mechanism.

FIG. 13 shows another example of a combined use of a touch input mechanism and a pen input mechanism, where the touch input mechanism captures a multi-touch gesture.

FIG. 14 shows a flowchart which explains one manner of operation of the computing device of FIG. 1.

FIG. 15 shows another flowchart which explains another manner of operation of the computing device of FIG. 1.

FIG. 16 shows illustrative processing functionality that can be used to implement any aspect of the features shown in the foregoing drawings.

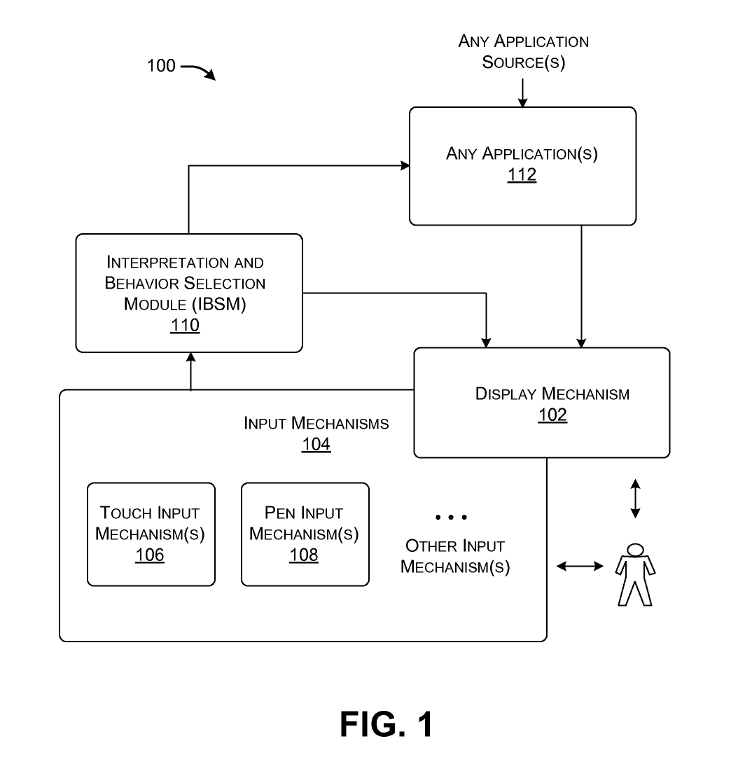

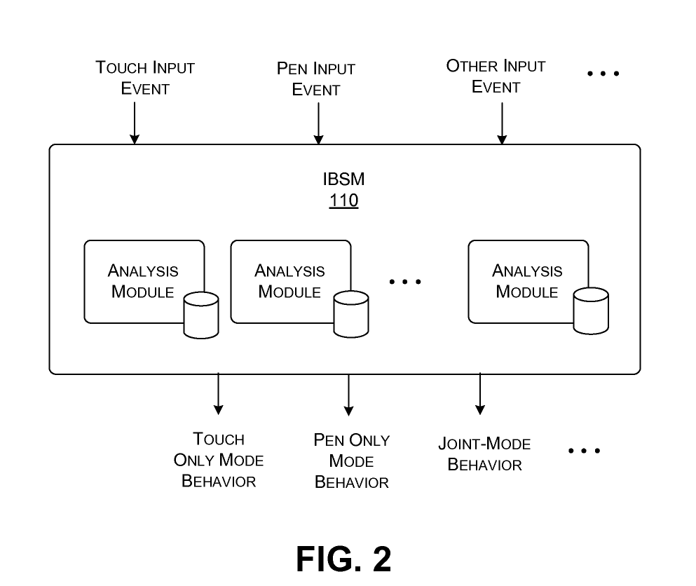

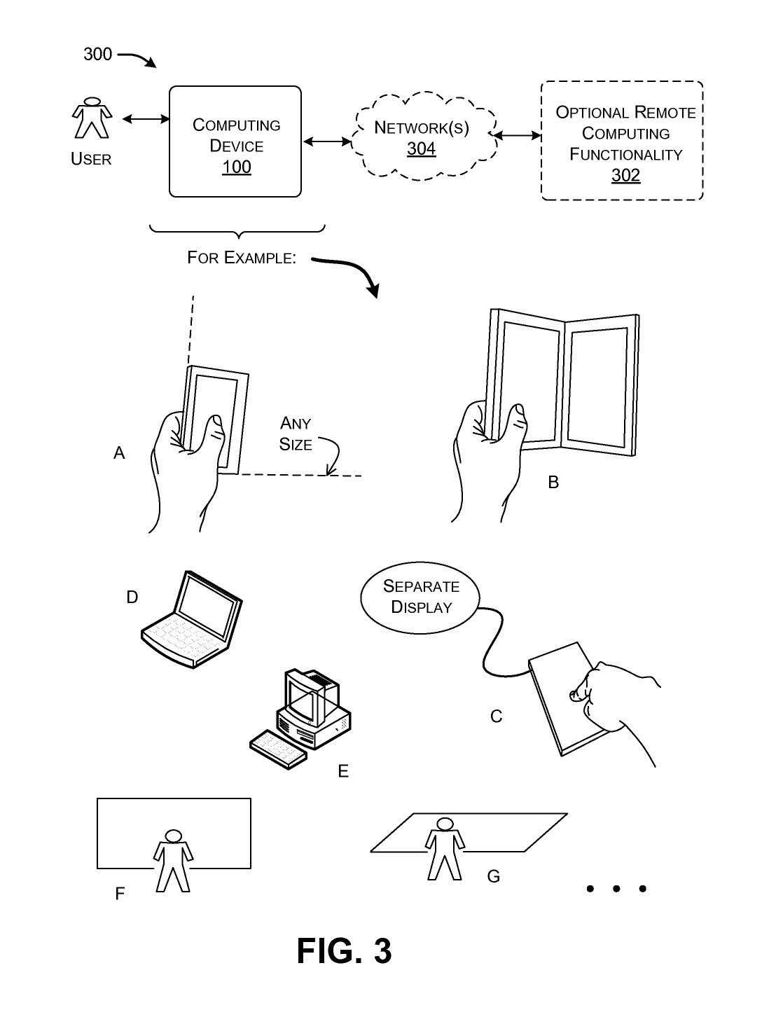

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative computing device that accommodates cooperative use of two input mechanisms. Section B describes illustrative methods which explain one manner of operation of the computing device of Section A. Section C describes illustrative processing functionality that can be used to implement any aspect of the features described in Sections A and B.

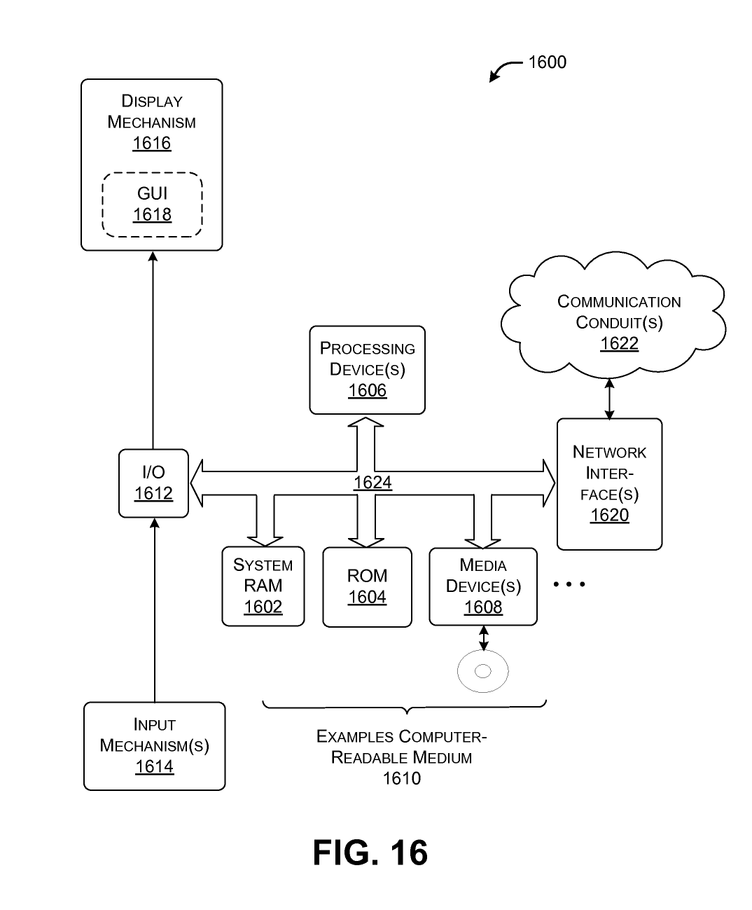

As a preliminary matter, some of the figures describe concepts in the context of one or more structural components, variously referred to as functionality, modules, features, elements, etc. The various components shown in the figures can be implemented in any manner by any physical and tangible mechanisms (such as by hardware, software, firmware, etc., or any combination thereof). In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 16, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms (such as by hardware, software, firmware, etc., or any combination thereof).

As to terminology, the phrase “configured to” encompasses any way that any kind of physical and tangible functionality can be constructed to perform an identified operation. The functionality can be configured to perform an operation using, for instance, software, hardware, firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware, firmware, etc., and/or any combination thereof. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Computing Devices

A.1. Overview

FIG. 1 shows an example of a computing device 100 that can accommodate the use of two or more input mechanisms in cooperative conjunction. To facilitate the description, the following explanation will set forth examples in which two input mechanisms are used in combination. However, the computing device 100 can accommodate the joint use of more than two input mechanisms. Further, the following explanation will set forth many examples in which the two input mechanisms correspond to two distinct modules that use different input paradigms. However, the term “two input mechanisms” encompasses two different applications of the same input technology, such as two different applications of touch input technology.

The computing device 100 may include an optional display mechanism 102 in conjunction with various input mechanisms 104. The display mechanism 102 provides a visual rendering of digital information on a display surface. The display mechanism 102 can be implemented by any type of display technology, such as, but not limited to, liquid crystal display technology, etc. Although not shown, the computing device 100 can also include an audio output mechanism, a haptic (e.g., vibratory) output mechanism, etc.

The computing device 100 includes plural input mechanisms 104 which allow a user to input commands and information to the computing device 100. For example, the input mechanisms 104 can include touch input mechanism(s) 106 and pen input mechanism(s) 108. Although not specifically enumerated in FIG. 1, other input mechanisms can include a keypad input mechanism, a mouse input mechanism, a voice input mechanism, and so on. The computing device 100 can also include various supplemental input mechanisms, such as an accelerometer, a gyro device, a video camera, a depth sensing mechanism, a stereo imaging device, and so on.

The touch input mechanism(s) 106 can be physically implemented using any technology, such as a resistive touch screen technology, capacitive touch screen technology, acoustic touch screen technology, bi-directional touch screen technology, and so on. In bi-direction touch screen technology, a display mechanism provides elements devoted to displaying information and elements devoted to receiving information. Thus, a surface of a bi-directional display mechanism also serves as a capture mechanism. Likewise, the pen input mechanism(s) 108 can be implemented using any technology, such as passive pen technology, active pen technology, and so on. The touch input mechanism(s) 106 and pen input mechanism(s) 108 can also be implemented using a pad-type input mechanism that is separate from (or at least partially separate from) the display mechanism 102. A pad-type input mechanism is also referred to as a tablet, a digitizer, a graphics pad, etc.

FIG. 1 depicts the input mechanisms 104 as partially overlapping the display mechanism 102. This is because at least some of the input mechanisms 104 may be integrated with functionality associated with the display mechanism 102. This may be the case with respect to the touch input mechanism(s) 106 and pen input mechanism(s). For example, the touch input mechanism(s) 106 may rely, in part, on functionality provided by the display mechanism 102.

In the terminology used herein, each input mechanism is said to generate an input event when it is invoked by the user. For example, when a user touches the display surface of the display mechanism 102, the touch input mechanism(s) 106 generates touch input events. When the user applies a pen device to the display surface, the pen input mechanism(s) 108 generates pen input event(s). A gesture refers to any input action made by the user via any input modality. A gesture may itself be composed of two or more component gestures, potentially generated using two or more input modalities. For ease and brevity of reference, the following explanation will most often describe the output of an input mechanism in the plural, e.g., as “input events.” However, various analyses can also be performed on the basis of a singular input event.

An interpretation and behavior selection module (IBSM) 110 receives input events from the input mechanisms 104. As the name suggests, the IBSM 110 performs the task of interpreting the input events, e.g., by mapping the input events to corresponding gestures. It performs this operation by determining whether one of three modes have been invoked by the user. In a first mode, the IBSM 110 determines that a touch input mechanism is being used by itself, e.g., without a pen input mechanism. In a second mode, the IBSM 110 determines that a pen input mechanism is being used by itself, e.g., without a touch input mechanism. In a third mode, also referred to herein as a joint use mode, the IBSM 110 determines that both a touch input mechanism and a pen input mechanism are being used in cooperative conjunction. As noted above, the computing device 100 can accommodate the pairing of other input mechanisms (besides the touch input mechanism(s) 106 and the pen input mechanism(s) 108). Further, the computing device 100 can invoke the joint use mode for two different applications of the same input mechanism.

After performing its interpretation role, the IBSM 110 performs appropriate behavior. For example, if the user has added a conventional mark on a document using a pen device, the IBSM 110 can store this annotation in an annotation file associated with the document. If the user has entered a gesture, then the IBSM 110 can execute appropriate commands associated with that gesture (after recognizing it). More specifically, in a first case, the IBSM 110 executes a behavior at the completion of a gesture. In a second case, the IBSM 110 executes a behavior over the course of the gesture.

Finally, the computing device 100 may run one or more applications 112 received from any application source(s). The applications 112 can provide any higher-level functionality in any application domain. Further, the applications 112 can leverage the functionality of the IBSM 110 in various ways, such as by defining new joint use gestures, etc.

In one case, the IBSM 110 represents a separate component with respect to applications 112. In another case, one or more functions attributed to the IBSM 110 can be performed by one or more applications 112. For example, in one implementation, the IBSM 110 can interpret a gesture, while an application can select and execute behavior that is based on that interpretation. Accordingly, the concept of the IBSM 110 is to be interpreted liberally herein as encompassing functions that can be performed by any number of components within a particular implementation.

FIG. 2 shows another depiction of the IBSM 110 introduced in FIG. 1. As shown in FIG. 2, the IBSM 110 receives various input events. For example, the IBSM 110 receives touch input events from the touch input mechanism(s) 106, pen input events from the pen input mechanism(s) 108, as well as any other input events from any other input mechanisms. In response to these events, the IBSM 110 executes the appropriate behavior(s) based on its interpretation of the input events. The behavior(s) may entail actions associated with any of the touch-only mode, the pen-only mode, or the joint-use mode.

To function as described, the IBSM 110 can incorporate a suite of analysis modules, where the detection of different gestures may rely on different respective analysis modules. Any analysis module can rely on one or more techniques to classify the input events, including pattern-matching techniques, rules-based techniques, statistical techniques, and so on. For example, each gesture can be characterized by a particular telltale pattern of inputs events. To classify a particular sequence of input events, a particular analysis module can compare those input events against a data store of known patterns. Further, an analysis module can continually test its conclusions with respect to new input events that arrive.

FIG. 3 shows an illustrative system 300 in which the computing device 100 of FIG. 1 can be used. In this system 300, a user interacts with the computing device 100 to provide input events and receive output information. The computing device 100 can be physically implemented as any type of device, including any type of handheld device as well as any type of traditionally stationary device. For example, the computing device 100 can be implemented as a personal digital assistant, a mobile communication device, a pad-type device, a book reader device, a handheld game device, a laptop computing device, a personal computer device, a work station device, a game console device, a set-top box device, and so on. Further, the computing device 100 can include one or more device parts, some of which may have corresponding display parts. The device parts can be coupled together with any type of hinge mechanism.

FIG. 3 also depicts a representative (but non-exhaustive) collection of implementations of the computing device 100. In scenario A, the computing device 100 is a handled device having any size. In scenario B, the computing device 100 is a book-reader device having multiple device parts. In scenario C, the computing device 100 includes a pad-type input device, e.g., whereby a user makes touch and/or pen gestures on the surface of the pad-type input device rather than (or in addition to) the display surface of the display mechanism 102. The pad-type input device can be integrated with the display mechanism 102 or separate therefrom (or some combination thereof). In scenario D, the computing device 100 is a laptop computer having any size. In scenario E, the computing device 100 is a personal computer of any type. In scenario F, the computing device 100 is associated with a wall-type display mechanism. In scenario G, the computing device 100 is associated with a tabletop display mechanism, and so on.

In one scenario, the computing device 100 can act in a local mode, without interacting with any other functionality. Alternatively, or in addition, the computing device 100 can interact with any type of remote computing functionality 302 via any type of network 304 (or networks). For instance, the remote computing functionality 302 can provide applications that can be executed by the computing device 100. In one case, the computing device 100 can download the applications; in another case, the computing device 100 can utilize the applications via a web interface or the like. The remote computing functionality 302 can also implement any aspect(s) of the IBSM 110. Accordingly, in any implementation, one or more functions said to be components of the computing device 100 can be executed by the remote computing functionality 302. The remote computing functionality 302 can be physically implemented using one or more server computers, data stores, routing equipment, and so on. The network 304 can be implemented by any type of local area network, wide area network (e.g., the Internet), or combination thereof. The network 304 can be physically implemented by any combination of wireless links, hardwired links, name servers, gateways, etc., governed by any protocol or combination of protocols.

A.2. Examples of Cooperative Use of Two Input Mechanisms

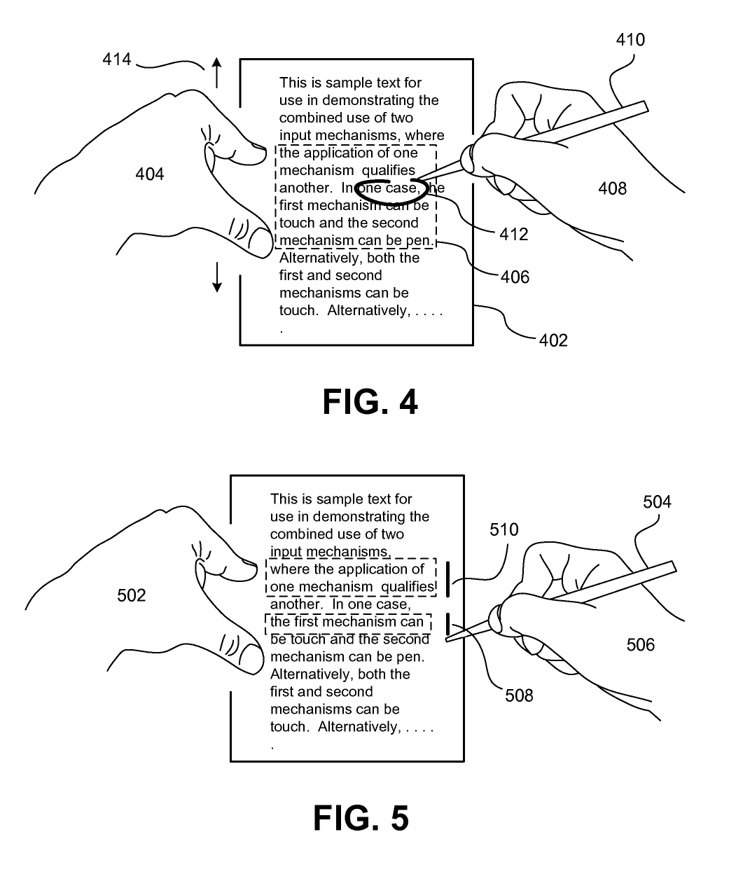

FIGS. 4-11 show various examples of the use of two input mechanisms in the joint use mode of operation. These examples are presented by way of illustration, not limitation. Other implementations can combine different input mechanisms, including more than two input mechanisms. Further, other implementations can define other types of gestures. Further, other implementations can define other mappings between gestures and behaviors. In this description, a general reference to a hand portion is to be understanding as encompassing any part of the hand, including plural parts of the user's hand.

In many of the examples which follow, the user is depicted as making contact with the display surface of the display mechanism 102. Alternatively, or in addition, the user can interact with a pad-type input device, e.g., as illustrated in scenario C of FIG. 3. Further, in the examples which follow, the assumption is made that the user makes contact input events by making physical (actual) contact with the display surface. Alternatively, or in addition, the computing device 100 can accept contact events which reflect the placement of a pen device and/or hand portion in close proximity to the display surface, without touching the display surface.

Starting with FIG. 4, this example shows a scenario in which a user cooperatively applies the touch input mechanism(s) 106 and the pen input mechanism(s) 108 to define a gesture on a display surface 402 of the display mechanism 102. Namely, the user first uses his or her left hand 404 to identify content 406 on the display surface 402. (To simplify the explanation, the user will henceforth be referred to using the pronoun “her.”) Namely, in this merely illustrative case, the user uses her index finger and thumb of the left hand 404 to frame a portion of text presented in a region on the display surface 402, thereby demarcating the bounds of the content 406 using two hand portions. The touch input mechanism(s) 106 generates touch input events in response to this action.

Next, the user uses her right hand 408 to identify a particular portion of the content 406 via a pen device 410. Namely, the user uses the pen device 410 to circle two words 412 within the demarcated content 406. This is one of many possible gestures that the user can perform, as will be further emphasized below. The pen input mechanism(s) 108 generates pen input events in response to this action. More generally, a user can apply any input technique to demarcate content (including a pen device) and any input technique to perform a marking action within the demarcated content. In other cases, the user can apply the marking action prior to the demarcating action, and/or the user can apply the marking action at the same time as the demarcating action.

The IBSM 110 receives the touch input events (originating from actions made with the left hand 404) and the pen input events (originating from actions made with the right hand 408). In response, the IBSM 110 first determines whether the joint use mode has been invoked. It can reach this conclusion by comparing the gestures exhibited by the input events with a database of valid gestures. In particular, the IBSM 110 can interpret the telltale framing action of the left hand 404 as an indication that the user wishes to invoke the joint use mode. The IBSM 110 then interprets the nature of the particular compound gesture that the user has made and executes the behavior associated with that gesture. Here, the user has lassoed two words 412 within content 406 demarcated by the left hand 404. The IBSM 110 can interpret this gesture as a request to highlight the two words 412, copy the two words, perform a spell check on the two words, etc. Other gesture-to-command mappings are possible.

More generally stated, the user applies her left hand 404 to set a context that biases the interpretation of any pen gestures that occur within the bounds defined by the context. Hence, the left hand 404 operates as a mode-switching mechanism. That mode-switching mechanism has a spatial scope of applicability defined by the index finger and thumb of the user's left hand 404. The user can remove the joint-use mode by lifting her left hand 404 from the display surface 402. The two-finger gesture shown in FIG. 4 is distinguished from the familiar pinch-to-zoom gesture because, in the case of FIG. 4, the user does not move the two fingers for a predetermined period of time after applying the fingers to the display surface 402.

In one case, the IBSM 110 optionally provides visual cues which assist the user in discriminating between the selected content 406 and other information presented by the display surface 402. For example, the IBSM 110 can gray out or otherwise deemphasize the non-selected information. Alternatively, or in addition, the IBSM 110 can independently highlight the selected content 406 in any manner.

The arrows (e.g., arrow 414) shown in FIG. 4 indicate that the user may dynamically change the spatial scope of the context established by the left hand 404, e.g., by moving her index finger and thumb closer together or farther apart after the joint-use mode has been established. The user can receive feedback from this operation by observing changes in the visual cues used to designate the selected content 406. In another example, the user can define a first span with the left hand 404 and then make a change with the right hand 408 which applies to the entirety of the content 406 associated with the first span. The user can then define a second span with the left hand 404, e.g., by moving her index finger and thumb in the manner described above. In response, the IBSM 110 can automatically apply whatever command has been invoked by the right hand 408 to the new spatial scope of the content 406.

FIG. 5 shows another scenario in which a user cooperatively applies the touch input mechanism(s) 106 and the pen input mechanism(s) 108 to define a compound gesture. Again, the user has defined content within a text document using her index finger and thumb of her left hand 502. And again, the user uses the pen device 504 with her right hand 506 to make a pen gesture within the context established by the left hand 502. In this case, the user places two vertical marks (508, 510) in the right hand margin of the demarcated content. In doing so, the user instructs the IBSM 110 to selectively execute operations on the text adjacent to the vertical marks (508, 510). In this manner, the user can make any number of disjoint selections using the pen device 504 within an encompassing context established by the left hand 502. In another use case, the user can again make one or more selections within the context established by the left hand 502, e.g., as shown in FIG. 5. If so configured, the IBSM 110 can interpret this gesture as a request to omit the content associated with the selection(s) from the overall content demarcated by the left hand 502. For example, the user can use the left hand 502 to identify a portion of a list, and then use a selection within that context to exclude parts of that list. This type of gesture can involve any number of such selections, which are interpreted as respective omission requests.

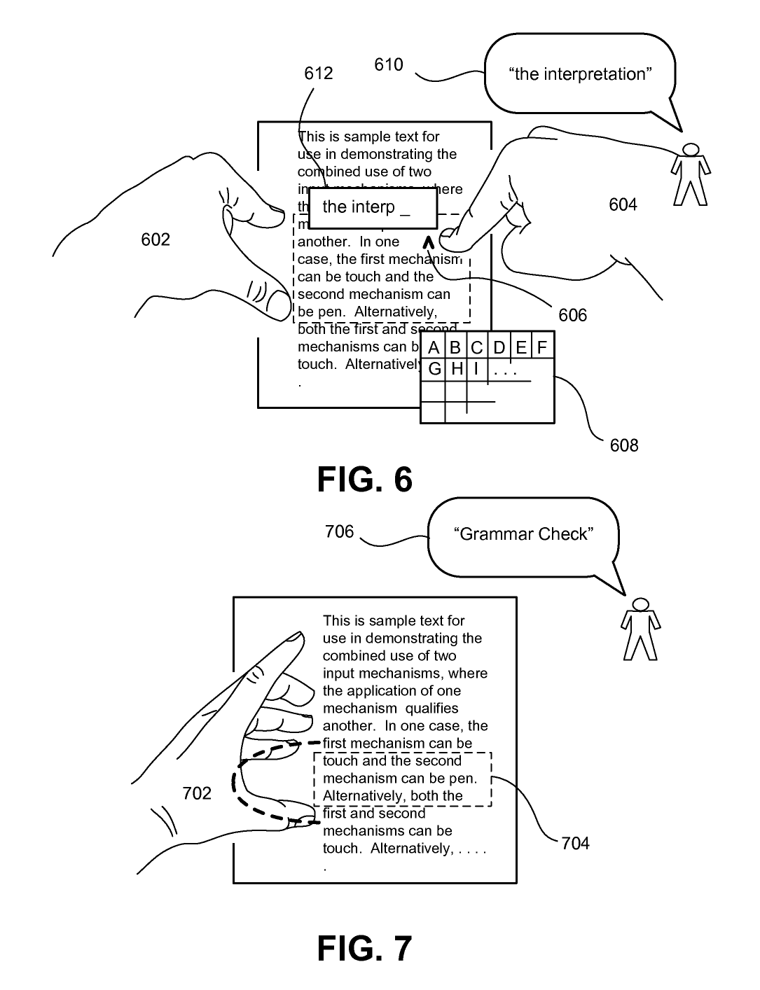

FIG. 6 shows another scenario in which the user applies two input mechanisms in the joint use mode of operation. In this case, however, the two input mechanisms comprise two applications of the touch input mechanism(s) 106. Namely, the user again uses her left hand 602 to demarcate content that is presented on the display surface. But instead of using a pen device, the user uses her right hand 604 to make a secondary gesture within the context established by the left hand 602. In one case, the IBSM 110 can interpret such secondary gestures in a different manner depending on whether a pen device is used or a finger is used (or multiple fingers are used).

In this particular scenario, the user uses her right hand 604 to tap down on the display surface. The IBSM 110 interprets this action as a request to insert text at the designated location of the tap. In response, the IBSM 110 may present a carat 606 or other visual cue to mark the designated location of insertion. The computing device 100 can allow the user to input text at the insertion point in various ways. In one case, the computing device 100 can present a touch pad 608 or the like which allows the user to input the message by pressing keys (with the right hand 604) on the key pad 608. In another case, the computing device 100 can allow the user to enter an audible message, as indicated by the voice bubble 610. In another case, the computing device 100 can allow the user to enter text via a pen input device, or the like. In the case of the use of an audio input mechanism or a pen input mechanism, the computing device 100 can recognize the text that has been entered and convert it to an appropriate alphanumeric form before inserting it at the insertion point. Alternatively, or in addition, the computing device 100 can maintain an audio message or a handwritten message in original (unrecognized) format, e.g., as freeform ink strokes in the case of a handwritten message. In any case, FIG. 6 shows an illustrative input box 612 which provides feedback to the user regarding the new text that has been received.

FIG. 7 shows another scenario in which the user applies two input mechanisms in the joint use mode of operation. In this case, the user again uses the left hand 702 to frame the content 704 on a display surface of the display mechanism 102. But in this case, the user makes a cupping gesture with her thumb and pinky, where a substantial portion of the “cup” thus formed is in contact with the display surface. The “cup” frames the content 704.

Further, in the scenario of FIG. 7, instead of a pen device, the user provides an audible command that applies to the content 704. For example, as indicated by the voice bubble 706, the user voices the command “grammar check.” The IBSM 110 recognizes this command and interprets it as a request to perform a grammar check on the text associated with the content 704. The examples of FIGS. 6 and 7 more generally illustrate how various gesture-combinations of touch input, pen input, audio input, and any other input can synergistically combine to provide an effective and user-friendly mechanism for designating and acting on content.

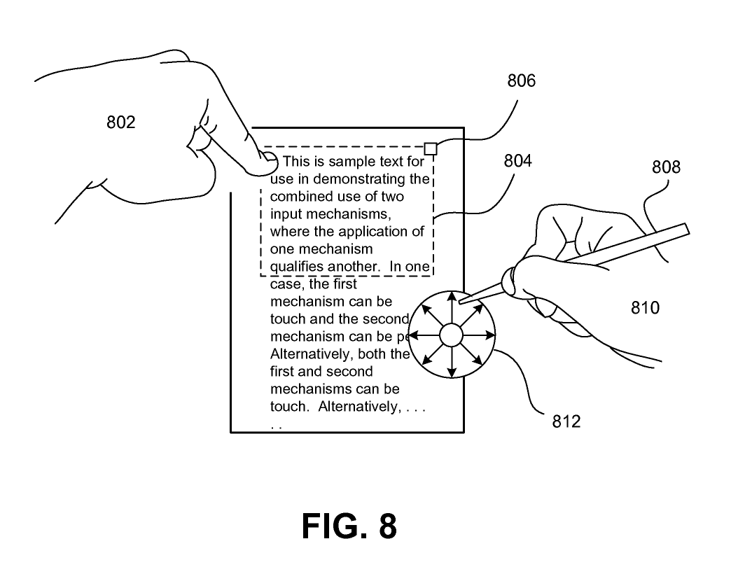

FIG. 8 shows another scenario in which the user applies two input mechanisms in the joint use mode of operation. In this case, the user again uses the left hand 802 to demarcate content 804. Namely, in this case, the user uses a single finger to point to a paragraph within a multi-paragraph document displayed on the display surface. The IBSM 110 interprets this touch command as a request to select the entire paragraph. This behavior can be modified in various ways. For example, the user can tap once on a sentence to designate that individual sentence. The user can tap twice in quick succession to designate the entire paragraph. The user can tap three times in quick succession to designate a yet larger unit of text.

Further note that, as a result of the user's selection via the left hand 802, the IBSM 110 presents a visual cue 806 in the right hand top corner of the content 804, or in any another application-specific location. More specifically, in one case, an application can present such a cue 806 in a predetermined default location (or at one of a number of default locations); alternatively, or in addition, an application can present the cue 806 at a location that takes into account one or more contextual factors, such as the existing arrangement of content on the display surface, etc. This visual cue 806 indicates that there is a command menu associated with the selected content 804. The command menu identifies commands that the user may select to perform respective functions. These functions may be applied with respect to text associated with the content 804.

In one case, the user can activate the menu by hovering over the visual cue 806 with a pen device 808 (or a finger touch, etc.), operated using the right hand 810. Or the user may expressly tap on the visual cue 806 with the pen device 808 (or finger touch, etc.). The IBSM 110 can respond by displaying a menu of any type. The IBSM 110 can display the menu in a default region of the display surface (or in one of a number of default regions), or the IBSM 110 can display the menu in a region which satisfies one or more contextual factors. For instance, the IBSM 110 can display the menu in a region that does not interfere with (e.g., overlap) the selected content 804, etc. In the particular illustrative example depicted in FIG. 8, the IBSM 110 presents a radial menu 812, also known as a marking menu. A user can make a mark in one of the radial directions identified by the menu 812 to invoke a corresponding command. Again, the IBSM 110 will then apply that command to the text associated with the content 804. For example, the user can make a downward vertical mark in the menu 812 to instruct the IBSM 110 to highlight the content 804. Upon repeated used of the menu 812, the user may learn the mapping between stroke gestures and associated commands. If so, the user can immediately apply an appropriate stroke gesture to execute a desired command without first activating or visually attending to the menu 812. In another implementation, the IBSM 110 can automatically present the menu 812 when triggered by contextual actions made by the user within the content 804, e.g., instead of, or in addition to, expressly invoking the menu 804 by activating the cue 806.

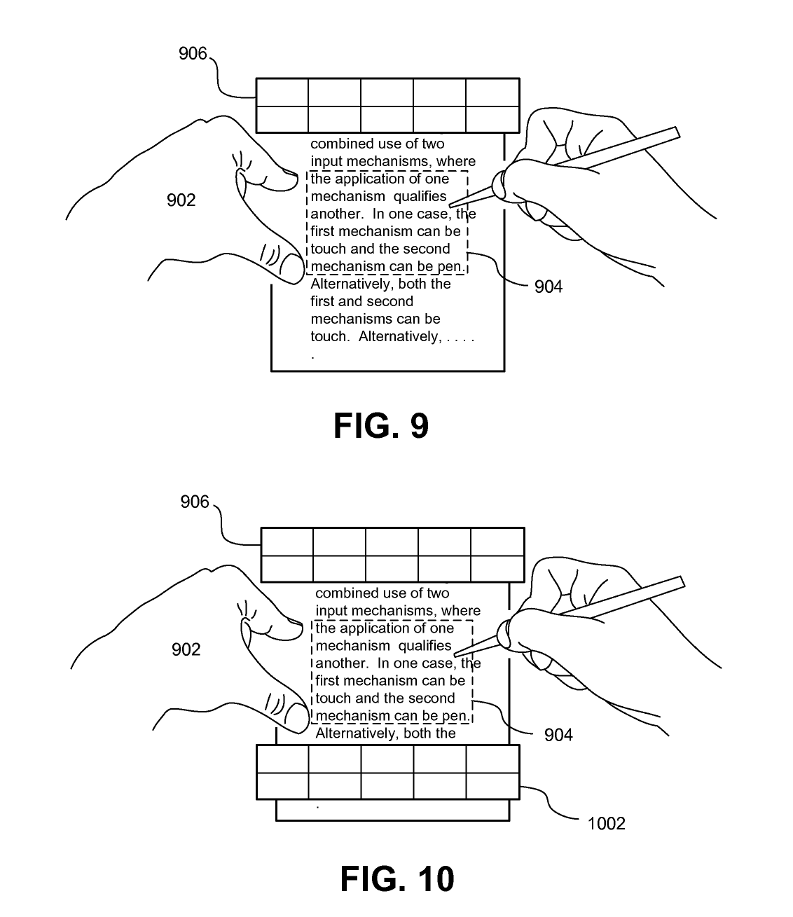

FIG. 9 is another example in which the computing device 100 presents a menu. In this example, the user uses her left hand 902 to demarcate content 904. This also triggers the IBSM 110 to present a pallet menu 906 at a convenient location with respect to the content 904. In this particular example, the IBSM 110 displays the palette menu 906 immediately above the content 904. In the related example of FIG. 10, the IBSM 110 can also display a second pallet menu 1002 below the content 904. These are merely representative examples. Alternatively, or in addition, the IBSM 110 can display a menu as an overlay over at least part of the content 904. Alternatively, or in addition, the IBSM 110 can adjust the sizes of one or more menus that it presents. Alternatively, or in addition, the IBSM 110 and/or any application(s) 112 can present an assortment of different types of menus, such as one or more radial menus in combination with one or more palette menus, and/or any other type(s) of menu(s).

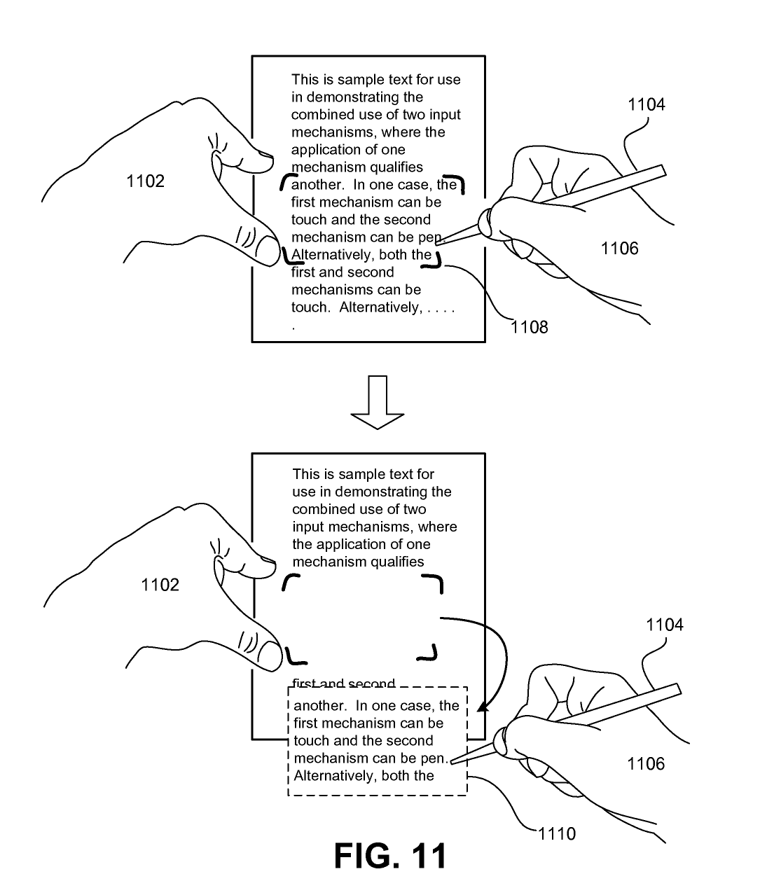

FIG. 11 shows another scenario in which the user applies two input mechanisms in the joint use mode of operation. In this case, the user executes a gesture that includes two parts or phases. In a first phase, the user applies her left hand 1102 to frame particular content on the display surface. The user then uses the pen device 1104, operated by her right hand 1106, to identify a portion of the content. For example, the user can identify the portion by adding crop marks around the portion. Crop mark 1108 is one such crop mark added by the user in this example. In a second phase, the user uses the pen device 1104 (or a touch input) to move the portion identified by crop marks to another location. FIG. 11 identifies the extracted portion as portion 1110. Other compound gestures can include more than two phases of component gestures.

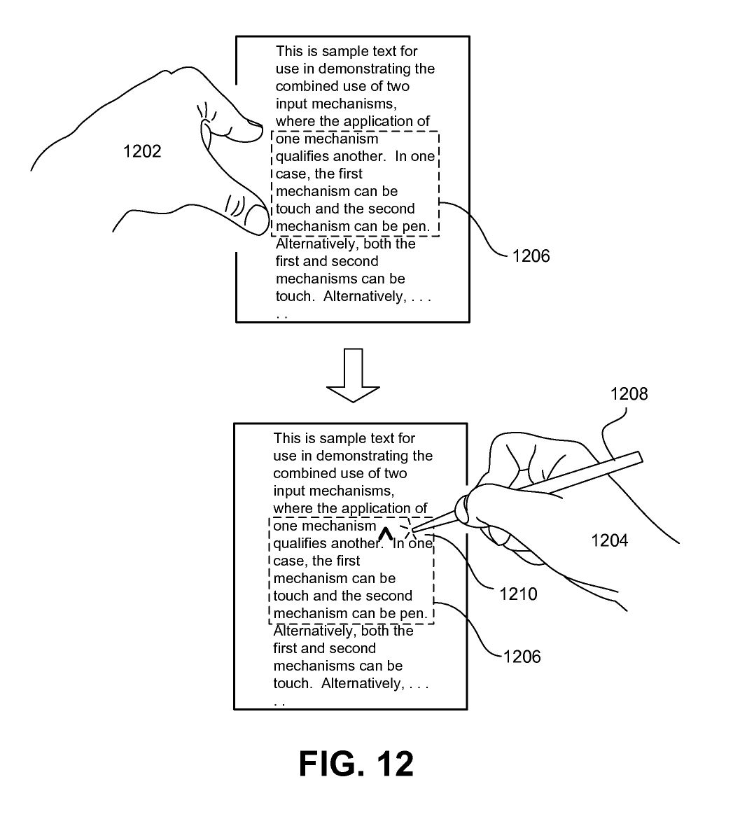

FIG. 12 shows another scenario in which the user applies two input mechanisms to convey a gesture in the joint use mode of operation. However, in this example, the user first applies and removes the left hand 1202, followed by application of the right hand 1204. By contrast, in the above examples, the user's application of the left hand at least partially overlaps the user's application of the right hand in time.

More specifically, the user uses her left hand 1202 to identify the content 1206 on the display surface. The IBSM 110 interprets this action as a request to invoke the joint use mode of action. The IBSM 110 activates this mode for a prescribed time window. The user can then remove her left hand 1202 from the display surface while the IBSM 110 continues to apply the joint use mode. Then, the user uses the pen device 1208 with the right hand 1204 to mark an insertion point 1210 in the content 1206, e.g., by taping on the location at which the inserted text is to appear. Insofar as the user performs this action within the joint use time window, the IBSM 110 will interpret the action taken by the user with her left hand 1202 in conjunction with the context-setting action performed by the right hand 1004. If the user performs the action with the right hand 1204 after the time window has expired, the IBSM 110 will interpret the user's pen gestures as a conventional pen marking gesture. In this example, the user may alternatively exclusively use the left hand 1202 or the right hand 1204 to perform both the framing gesture and the tapping gesture. This implementation may be beneficial in a situation in which the user cannot readily use two hands to perform a gesture, e.g., when the user is using one hand to hold the computing device 100.

The implementation of FIG. 12 can be varied in one or more respects. For example, instead of a time-out window, the IBSM 110 can maintain the joint-use mode in an active state until the user expressly deactivates this mode, e.g., by providing an appropriate command. In another case, the user can vary the scope of the content 1206 after it is initially designated in the manner specified in FIG. 4, e.g., by reapplying two fingers and adjusting the span of the designated content.

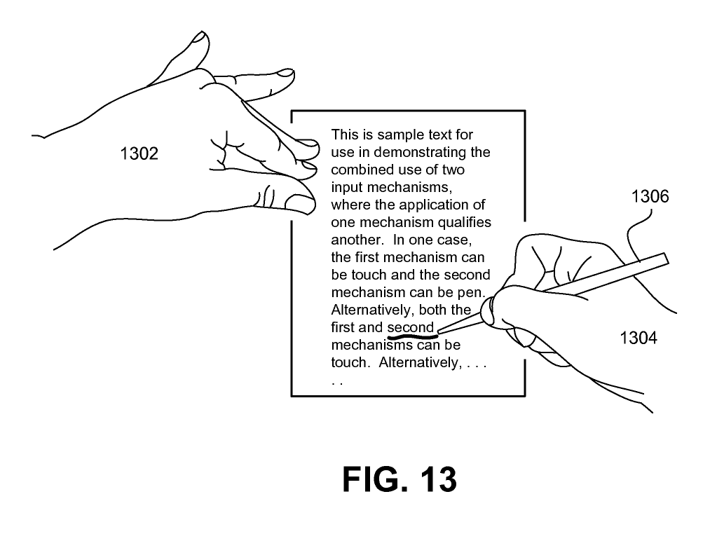

Finally, FIG. 13 shows another scenario in which the user uses two input mechanisms to convey a gesture in the joint use mode of operation. Here, the user uses her left hand 1302 to demarcate content on the display surface. The user uses her right hand 1304 to mark a portion of the demarcated content using a pen device 1306. This case differs from previous examples insofar as the user demarcates the content with her left hand 1302 using a different hand gesture, e.g., compared to the example of FIG. 4. In the example of FIG. 13, the user applies two fingers and a thumb onto the display surface in proximity to an identified paragraph. The point of this example is to indicate that a compound or idiosyncratic touch gesture can be used to designate content. The use of such a gesture reduces the risk that a user may accidently designate content by touching the display surface in a conventional manner to perform other tasks.

In another use case, a user can use a particular gesture to designate a span of content that cannot be readily framed using the two-finger approach described above. For example, the user can apply the type of gesture shown in FIG. 13 to designate an entire page, or an entire document, etc.

B. Illustrative Processes

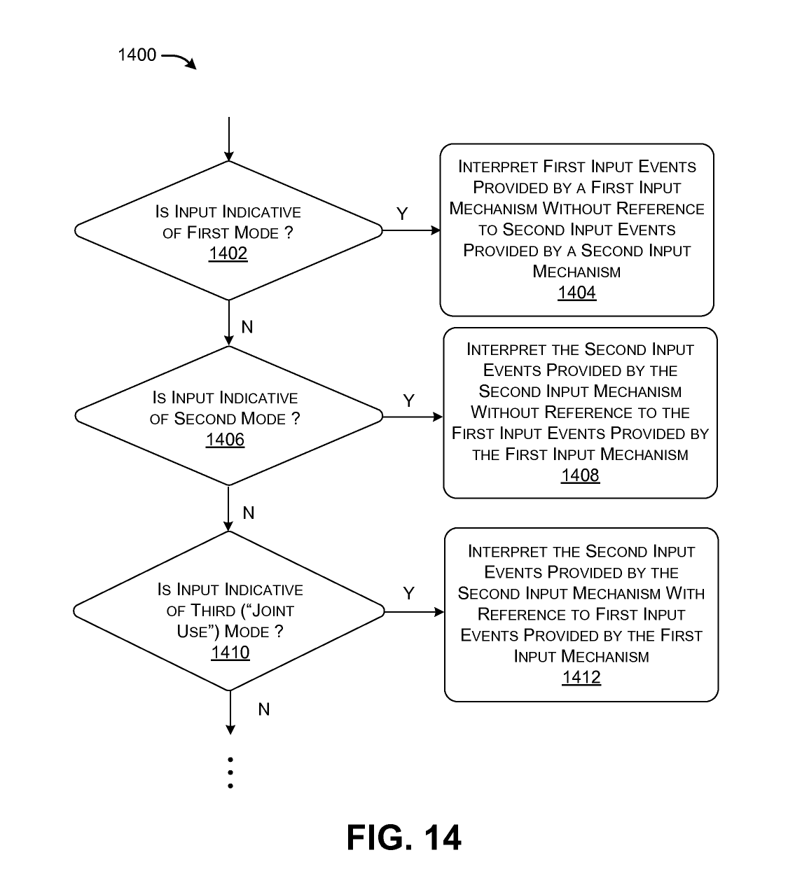

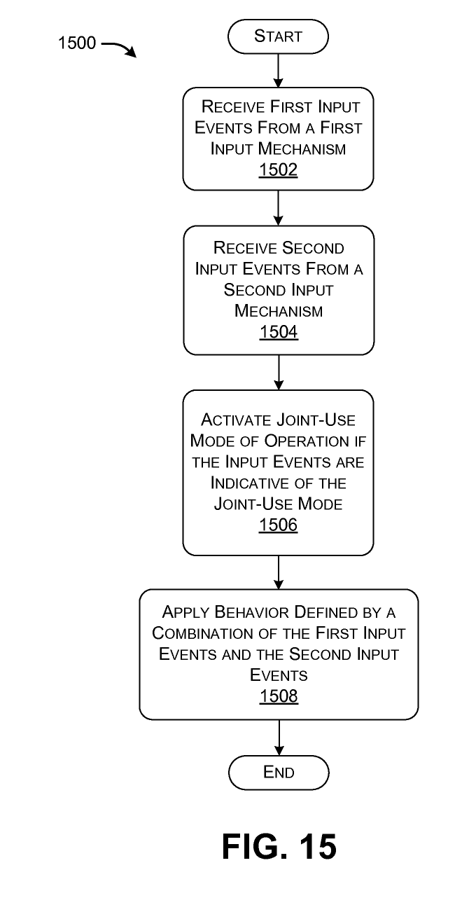

FIGS. 14 and 15 show procedures that illustrate one manner of operation of the computing device 100 of FIG. 1. Since the principles underlying the operation of the computing device 100 have already been described in Section A, certain operations will be addressed in summary fashion in this section.

Starting with FIG. 14, this figure shows a procedure 1400 which sets forth one way in which the IBSM 110 can activate and operate within various modes. In block 1402, the IBSM 110 determines whether first input events received from a first input mechanism are indicative of a first mode. For example, the IBSM 110 can interpret single finger contact gestures or the like in the absence of any other input events as indicative of the first mode. In response, in block 1404, the IBSM 110 interprets the first input events provided by the first input mechanism in a normal fashion, e.g., without reference to any second input events provided by a second input mechanism.

In block 1406, the IBSM 110 determines whether second input events received from a second input mechanism are indicative of a second mode. For example, the IBSM 110 can interpret isolated pen gestures as indicative of the second mode. In response, in block 1408, the IBSM 110 interprets the second input events provided by the second input mechanism in a normal fashion, e.g., without reference to any first input events provided by the first input mechanism.

In block 1410, the IBSM 110 determines whether first input events and second input events are indicative of a third mode, also referred to herein as the joint use mode of operation. As explained above, the IBSM 110 can sometimes determine that the joint use mode has been activated based on a telltale touch gesture made by the user, which operates to frame content presented on a display surface. If the joint use mode has been activated, in block 1412, the IBSM 110 interprets the second input events with reference to the first input events. In effect, the first input events qualify the interpretation of the second input events.

FIG. 15 shows a procedure 1500 which provide additional information regarding one way in which the joint use mode can be activated. In block 1502, the IBSM 110 receives first input events from a first input mechanism. In block 1504, the IBSM 110 receives second input events from a second input mechanism. In block 1506, the IBSM 110 activates the joint use mode if one or more of the first input events and the second input events are indicative of the joint use mode. In block 1508, the IBSM 110 applies a behavior defined by whatever gesture is conveyed by the combined use of the first input mechanism and the second input mechanism.

Although not expressly illustrated in these figures, the IBSM 110 can continually analyze input events produced by a user to interpret any gesture that the user may be attempting to make at the present time, if any. In some instances, the IBSM 110 can form a tentative interpretation of a gesture that later input events further confirm. In other cases, the IBSM 110 can form a tentative conclusion that proves to be incorrect. To address the later situations, the IBSM 110 can delay execution of gesture-based behavior if it is uncertain as to what gesture the user is performing Alternatively, or in addition, the IBSM 110 can begin to perform one or more possible gestures that may correspond to an input action that the user is performing The IBSM 110 can take steps to later reverse the effects of any behaviors that prove to be incorrect.

In other cases, the IBSM 110 can seamlessly transition from one gesture to another based on the flow of input events that are received. For example, the user may begin by making handwritten notes on the display surface using the pen device, without any touch contact applied to the display surface. Then the user can apply a framing-type action with her hand. In response, the IBSM 110 can henceforth interpret the pen strokes as invoking particular commands within the context established by the framing action. In another example, the user can begin by performing a pinch-to-zoom action with two fingers. If the user holds the two fingers still for a predetermined amount of time, the IBSM 110 can change its interpretation of the gesture that the user is performing, e.g., by now invoking the joint-use mode described herein.

C. Representative Processing Functionality

FIG. 16 sets forth illustrative electrical data processing functionality 1600 that can be used to implement any aspect of the functions described above. With reference to FIG. 1, for instance, the type of processing functionality 1600 shown in FIG. 16 can be used to implement any aspect of the computing device 100. In one case, the processing functionality 1600 may correspond to any type of computing device that includes one or more processing devices. In all cases, the electrical data processing functionality 1600 represents one or more physical and tangible processing mechanisms.

The processing functionality 1600 can include volatile and non-volatile memory, such as RAM 1602 and ROM 1604, as well as one or more processing devices 1606. The processing functionality 1600 also optionally includes various media devices 1608, such as a hard disk module, an optical disk module, and so forth. The processing functionality 1600 can perform various operations identified above when the processing device(s) 1606 executes instructions that are maintained by memory (e.g., RAM 1602, ROM 1604, or elsewhere).

More generally, instructions and other information can be stored on any computer readable medium 1610, including, but not limited to, static memory storage devices, magnetic storage devices, optical storage devices, and so on. The term computer readable medium also encompasses plural storage devices. In all cases, the computer readable medium 1610 represents some form of physical and tangible entity.

The processing functionality 1600 also includes an input/output module 1612 for receiving various inputs from a user (via input mechanism 1614), and for providing various outputs to the user (via output modules). One particular output mechanism may include a display mechanism 1616 and an associated graphical user interface (GUI) 1618. The processing functionality 1600 can also include one or more network interfaces 1620 for exchanging data with other devices via one or more communication conduits 1622. One or more communication buses 1624 communicatively couple the above-described components together.

The communication conduit(s) 1622 can be implemented in any manner, e.g., by a local area network, a wide area network (e.g., the Internet), etc., or any combination thereof. The communication conduit(s) 1622 can include any combination of hardwired links, wireless links, routers, gateway functionality, name servers, etc., governed by any protocol or combination of protocols.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device, comprising:
a first input mechanism for providing at least one first input event;
a second input mechanism for providing at least one second input event; and
an interpretation and behavior selection module (IBSM) for receiving at least one of said at least one first input event and said at least one second input event, the IBSM being configured to:
determine whether a first mode has been activated, upon which the IBSM is configured to interpret said at least one first input event without reference to said at least one second input event;
determine whether a second mode has been activated, upon which the IBSM is configured to interpret said at least one second input event without reference to said at least one first input event;
determine whether a third mode has been activated, upon which the IBSM is configured to interpret said at least one second input event with reference to said at least one first input event, said at least one first input event operating in cooperative conjunction with said at least one second input event.

2. The computing device of claim 1, wherein the computing device includes a display mechanism for providing a visual rendering of information on a display surface, and wherein the first input mechanism and the second input mechanism operate in conjunction with the display mechanism.

3. The computing device of claim 1, wherein the first input mechanism is a touch input mechanism for sensing actual or proximal contact of a hand with the computing device.

4. The computing device of claim 1, wherein the second input mechanism is a pen input mechanism for sensing actual or proximal contact of a pen device with the computing device.

5. The computing device of claim 1, wherein the second input mechanism is a touch input mechanism for sensing actual or proximal contact of a hand with the computing device.

6. The computing device of claim 1, wherein the second input mechanism is a voice input mechanism for sensing audible information.

7. The computing device of claim 1, wherein in the third mode, the IBSM is configured to interpret said at least one first input event as setting a context that applies to identified content that is displayed on a display surface by a display mechanism, and wherein the IBSM is configured to interpret said at least one second input event with reference to the context when said at least one second input event is encompassed by the context.

8. The computing device of claim 7, wherein said at least one second input event temporally overlaps said at least one first input event.

9. The computing device of claim 7, wherein said at least one second input event occurs following completion of an input action associated with said at least one first input event.

10. The computing device of claim 7, wherein the first input mechanism is configured to generate said at least one first input event when at least one hand portion is used to demarcate the content.

11. The computing device of claim 10, wherein said at least one hand portion comprises two or more hand portions which span the content.

12. The computing device of claim 10, wherein the second input mechanism is configured to generate said at least one second input event when a pen device is applied to the content demarcated by said at least one hand portion.

13. The computing device of claim 10, wherein the second input mechanism is configured to generate said at least one second input event when an input mechanism is applied to make one or more selections within the content demarcated by said at least one hand portion, to identify one or more parts of the content.

14. The computing device of claim 7, wherein the IBSM is configured to respond to said at least one first input event by providing at least one menu, and wherein the IBSM is configured to respond to said at least one second input event by activating an item within said at least one menu.

15. The computing device of claim 7, wherein said at least one second input event describes a multi-part input action that is applied to the content, the multi-part input action including at least two phases.

16. A method for controlling a computing device via at least two input mechanisms, comprising:
receiving at least one first input event from a first input mechanism in response to demarcation of content on a display surface of the computing device;
receiving at least one second input event from a second input mechanism in response to an input action applied to the content demarcated by the first input mechanism;
activating a joint-use mode of operation if it is determined that said at least one first input event and said at least one second input event are indicative of a cooperative use of the first input mechanism and the second input mechanism; and
applying a behavior defined by said at least one first input event and said at least one second input event, said at least one first input event qualifying said at least one second input event.

17. The method of claim 16, wherein the first input mechanism is a touch input mechanism for sensing contact of a hand with the display surface.

18. The method of claim 16, wherein the second input mechanism is a pen input mechanism for sensing a contact of a pen device with the display surface.

19. The method of claim 16, wherein said at least one first input event is generated when at least one hand portion is used to demarcate the content, and wherein said at least one second input event is generated when a pen device is applied to the content.

20. A computer readable medium for storing computer readable instructions, the computer readable instructions providing an interpretation and behavior selection module (IBSM) when executed by one or more processing devices, the computer readable instructions comprising:
logic configured to receive at least one touch input event from a touch input mechanism in response to demarcation of content on a display surface with at least two hand portions that span the content;
logic configured to receive at least one pen input event from a pen input mechanism in response to a pen input action applied to the content demarcated by said at least two hand portions; and
logic configured to activate a joint use mode of operation if it is determined that said at least one first input event and said at least one second input event are indicative of a cooperative use of the touch input mechanism and the pen input mechanism,
said at least one touch input event setting a context which qualifies interpretation of the said at least one pen input event in the joint use mode.
